(19) United States
(12) Patent Application Publication
(10) Pub. No.: US 2017/0189941 A1
(43) Pub. Date: Jul. 6, 2017

(54) CLEANING MECHANISMS FOR CHECK VALVES

(71) Applicant: Mark Taylor, Medford, OR (US)

(72) Inventor: Mark Taylor, Medford, OR (US)

(21) Appl. No.: 15/458,729

(22) Filed: Mar. 14, 2017

Related U.S. Application Data
(62) Division of application No. 14/718,864, filed on May 21, 2015.

(51) Int. Cl. B08B 3/02; F16K 15/14

(52) U.S. Cl. CPC B08B 3/02; F16K 15/14

(57) ABSTRACT

Check valves including in situ cleaning mechanisms are shown and described. The check valves include a side wall, an opening, a disc disposed within the opening and configured to be moveable between an open position and a closed position, and a cleaning mechanism. The cleaning mechanism includes a port in the side wall configured to be coupled to a fluid source to spray fluid onto an inner surface of the side wall and the disc to clear debris from the check valve. In some examples, the port is an access port configured to be coupled to a nozzle for coupling the fluid source to the port. In some further examples, the cleaning mechanism includes a handle operatively coupled to the disc to move the disc between the open position and the closed position.

### BACKGROUND

The present disclosure relates generally to check valve cleaning mechanisms and methods. In particular, check valves with in situ cleaning mechanisms (i.e., cleaning mechanisms that are usable when the check valve and surrounding components remain in their operable positions) including a fluid port for spraying pressurized fluid into the check valve are described.

Sewage, industrial effluent, and storm effluent can include debris, such as plastics, wire, branches, leaves, garbage, etc. In the case of sewage, debris can additionally be comprised of sanitary products, wipes, toilet paper, etc. Often drainage or channeling systems utilize check valves (i.e., one-way valves, non-return valves, etc.) to prevent fluid backflow in the system. Debris, such as the debris described above, can wrap around or otherwise attach to/collect within check valves and prevent full opening and/or full closure of the check valve. In some cases, such a condition in the check valve can allow backflow into the system and/or prevent outflow. Further, the system can become hydraulically inefficient, thereby reducing the actual flow rate output.

Known mechanisms and devices for cleaning check valves are not entirely satisfactory for the range of applications in which they are employed. For example, existing check valve cleaning practices and mechanisms require opening of the pipe system and/or removal of the check valve from the pipe system for cleaning and servicing. In this example, the drainage/channeling system must be shut down in order to clean the check valve, which can be an expensive and time-consuming process. Further, the service operator can be exposed to potentially harmful fluid and/or debris contained in the pipe system. In addition, conventional check valve cleaning practices and mechanisms can be ineffective in removal of debris and lead to faster corrosion of the check valve and/or failure to repair (i.e., improve) hydraulic efficiency of the system.

Thus, there exists a need for check valve cleaning mechanisms and methods that improve upon and advance the design of known check valves. Examples of new and useful check valves with in situ cleaning mechanisms and methods for cleaning check valves relevant to the needs existing in the field are discussed below.

Disclosure addressing one or more of the identified existing needs is provided in the detailed description below. Examples of references relevant to check valve cleaning mechanisms and methods include U.S. Patent References: U.S. Pat. No. 4,909,325 and U.S. Pat. No. 6,375,757. The complete disclosures of the above patents are herein incorporated by reference for all purposes.

### SUMMARY

The present disclosure is directed to check valves in a pipe systems, the check valves having a side wall, an opening substantially encompassed by the side wall, a disc disposed within the opening and configured to be selectively moveable between an open position and a closed position to correspondingly open and close the check valve in response to pressure within the pipe system, and a cleaning mechanism. The cleaning mechanism has at least one port in the side wall configured to be coupled to a fluid source and spray fluid from the fluid source onto one or more of an inner surface of the side wall and the disc to clear debris from the check valve. In some examples, the at least one port is an access port configured to be coupled to a nozzle for coupling the fluid source to the port. In some further examples, the cleaning mechanism further includes a handle operatively coupled to the disc and configured to move the disc between the open position and the closed position.

### BRIEF DESCRIPTION OF THE DRAWINGS

FIGS. 1A and 1B are schematic views of a first example pipe system including a first example of a check valve having an in situ cleaning mechanism.

FIG. 2 is a perspective view of the first example check valve having an in situ cleaning mechanism schematically depicted in FIGS. 1A and 1B.

FIG. 3 is a lateral cross-sectional view of the first example check valve depicted in FIG. 2.

FIG. 4 is a perspective view of the first example check valve FIG. 2 showing an example spray pattern with the valve in a closed position.

FIG. 5 is a perspective view of the first example check valve depicted in FIG. 2 showing an example spray pattern with the valve in an open position.

FIG. 6 is a perspective view of a peripheral cleaning device that can be used in combination with the first example check valve depicted in FIG. 2.

FIG. 7 is a perspective view of a peripheral cleaning device attached to a drill and inserted through the port of the first example check valve depicted in FIG. 2.

### DETAILED DESCRIPTION

The disclosed check valves with in situ cleaning mechanisms and methods for cleaning check valves will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various check valves with in situ cleaning mechanisms and methods for cleaning check valves are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

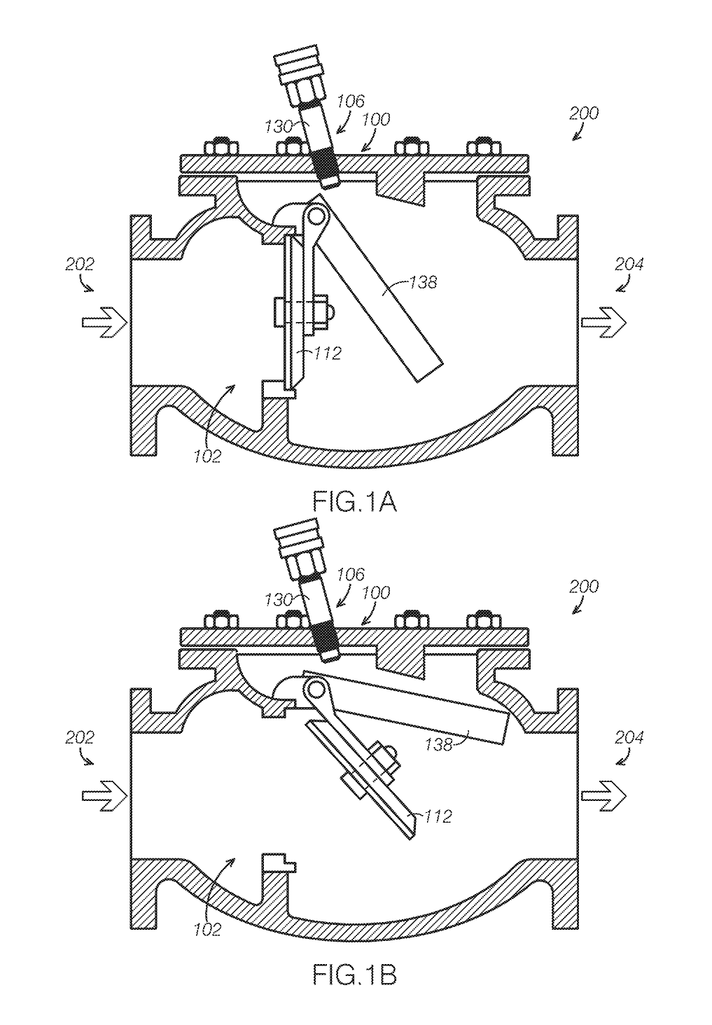

With reference to FIGS. 1A-5, a first example of a check valve with an in situ cleaning mechanism, check valve 100, will now be described. In general, check valve 100 functions to regulate hydraulic flow through a pipe system. Additionally or alternatively, check valve 100 can be used to clean, remove, and/or clear debris from check valve components without removal of the valve and/or otherwise disrupting operation of the pipe system. In some examples, check valve 100 is used in combination with and/or is a component of a pump volute and is configured to clean the pump volute and/or an impeller housed inside of the pump volute.

Check valve 100 addresses many of the shortcomings existing with conventional check valves. For example, as the check valve can be cleaned without removal and/or opening of the pipe system, the valve can be cleaned more quickly and with greatly reduced risk of exposure to fluid and debris within the system. Further, the pipe system does not have to temporarily shut down while cleaning is carried out. In fact, the cleaning mechanism can be operated while the pipe system is operable. Furthermore, the cleaning mechanism effectively cleans, removes, and/or clears debris from the check valve in order to repair/improve hydraulic efficiency of the pipe system.

As shown in FIGS. 1A and 1B, check valve 100 is a component of a pipe system 200 (e.g., a sewer system, a drainage system, etc.) and contributes regulation of hydraulic flow of a fluid (e.g., sewage, storm water, industrial waste, etc.) through pipe system 200. Pipe system 200 includes an upstream side 202 (i.e., a portion of the pipe system upstream of check valve 100) and a downstream side 204 (i.e., a portion of the pipe system downstream of check valve 100).

Check valve 100 specifically functions to regulate hydraulic flow by allowing flow from upstream side 202 to downstream side 204 and limiting and/or preventing backflow from downstream side 204 to upstream side 202. Accordingly, when a system pressure on the upstream side is below a threshold, check valve 100 remains in a substantially closed position 102 (shown in FIG. 1A), and when the system pressure on the upstream side is above the threshold, the check valve moves into a substantially open position 104 (shown in FIG. 1B). Additionally or alternatively, when a system pressure is greater on the downstream side than the upstream side, the check valve can remain in the substantially closed position. Further, when a system pressure is greater on the upstream side than the downstream side, the check valve can move into the substantially open position. It will be appreciated that the open position can be a variety of degrees of opening depending on the system pressure. Accordingly, the degree of opening of the check valve can vary between slightly open to fully open.

In the present example, check valve 100 is a wafer spring resilient check valve (i.e., swing check valve) that includes a spring mechanism to bias the check valve towards the closed position. As described above, in some examples, check valve 100 is used in combination with and/or is a component of a pump volute and is configured to clean the pump volute and/or an impeller housed inside of the pump volute. It will be appreciated that in alternate examples the check valve can be a potable water gate valve or any other type of known or yet to be discovered check valve.

Fluid moving through pipe system 200 often includes various types of debris (e.g., plastics, wire, branches, leaves, garbage, sanitary products, wipes, toilet paper, etc.), which can collect on downstream side 204 proximal to check valve 100 and prevent full opening and/or closing of check valve 100. Significantly, check valve 100 includes an in situ cleaning mechanism 106. Cleaning mechanism 106 is configured to clear debris from the downstream side of check valve 100. In examples where check valve 100 is used in combination with and/or is a component of a pump volute, check valve 100 is configured to clear debris and clean the pump volute and/or an impeller housed inside of the pump volute. Further, cleaning mechanism 106 can be operated while pipe system 200 is operable. Cleaning mechanism 106 is therefore capable of improving hydraulic efficiency of pipe system 200 by cleaning check valve 100 with limited disruption to operation of pipe system 200.

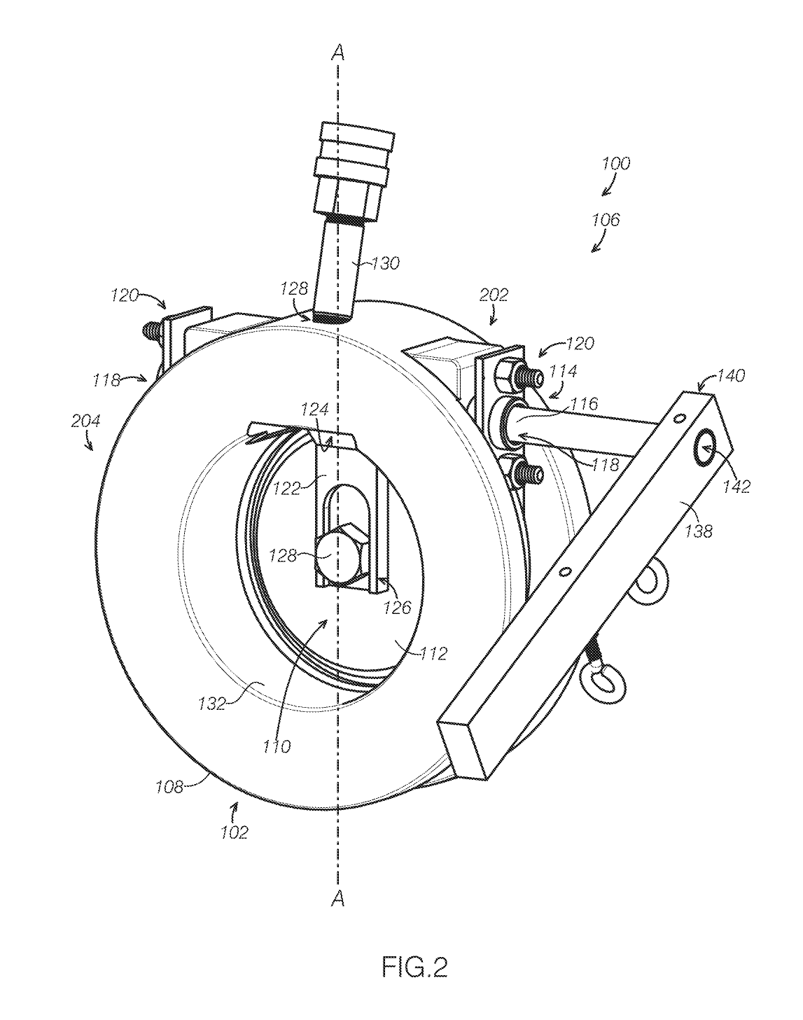

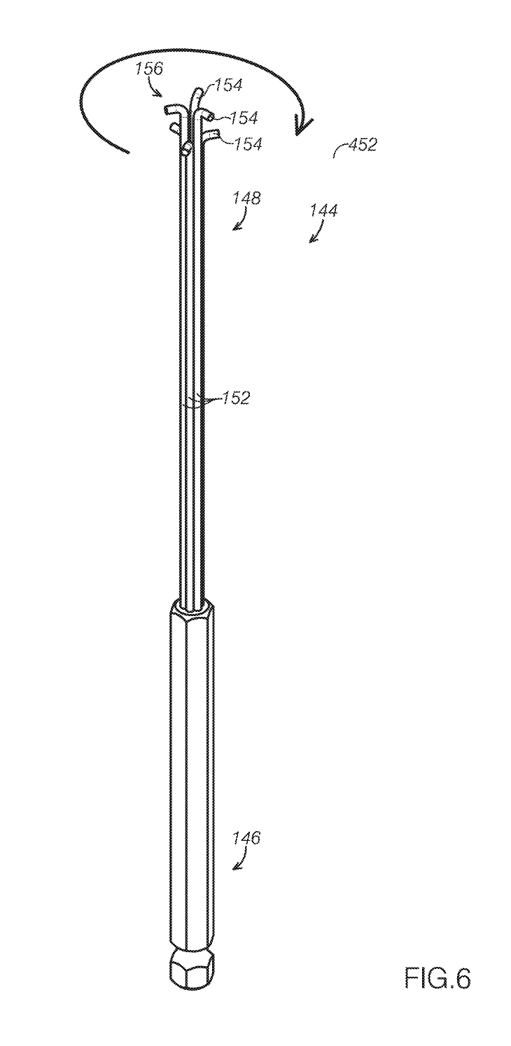

As can be seen in FIGS. 2-5, check valve 100 includes cleaning mechanism 106, a curved side wall 108 (i.e., a valve seat), an opening 110 (i.e., an annular area of the valve) substantially encompassed by the side wall, and a disc 112. Disc 112 is disposed within opening 110 moveable (e.g., pivotable) between closed position 102 (shown in FIGS. 1A and 2-4) and open position 104 (shown in FIGS. 1B and 6). In closed position 104, disc 112 substantially blocks opening 110, and in open position 102, disc 112 at least partially unblocks opening 110.

As can be seen in FIG. 2, disc 112 is operatively coupled to side wall 108 via a hinge mechanism 114. Hinge mechanism 114 includes a rod 116 rotatable within a laterally extended hole 118 in side wall 108 and attached to the side wall via attachment mechanisms 120. Hinge mechanism 114 further includes an arm 122 for coupling disc 112 to rod 116. Specifically, arm 122 is fixedly coupled to rod 116 at a first end 124 and fixedly coupled to a center of disc 112 at a second end 126. In the present example, arm 122 is substantially a flat plate that makes surface-to-surface contact with disc 112 and is coupled to the disc via a fastening member 128 inserted through aligned holes in the disc and the arm (not specifically shown). Further, first end 124 includes a tightenable sleeve 144 for receiving and retaining rod 116. It will be appreciated that in alternate examples the check valve can have a different configuration for pivotably attaching the disc to the side wall (i.e., valve seat).

Also shown in FIGS. 2-5, cleaning mechanism 106 includes a port 128 in side wall 108. Specifically, port 128 is disposed in the side wall proximal to hinge mechanism 114 (i.e., a top side of the check valve) on the downstream side of check valve 100. In alternate examples, the cleaning mechanism can include a port in a different location (e.g., a bottom of the check valve, a first side of the check valve, a second side of the check valve, etc.). Further, the cleaning mechanism can include more than one port in the side wall each disposed at a different location. Furthermore, the cleaning mechanism can additionally or alternatively include one or more ports on the upstream side of the check valve.

Port 128 is configured to be coupled with a nozzle 130 that is further coupled to a fluid source for spraying fluid from the fluid source onto an inner surface 132 of side wall 108 and/or the downstream side (downstream side 204) of disc 112 in order to clear debris from check valve 100. Accordingly, cleaning mechanism 106 is an in situ cleaning mechanism that it is capable of cleaning the check valve without removal of the check valve, opening of the pipe system, and/or shutting down of the pipe system. In pipe systems, check valves are often sandwiched between (i.e., disposed between) tightly fitted mechanical devices, such as pump ends and knife gates. Further, voltages of up to 480 V commonly power bigger sewage pumps. These factors make dismantling and removal of blockages complex and time consuming in conventional pipe systems.

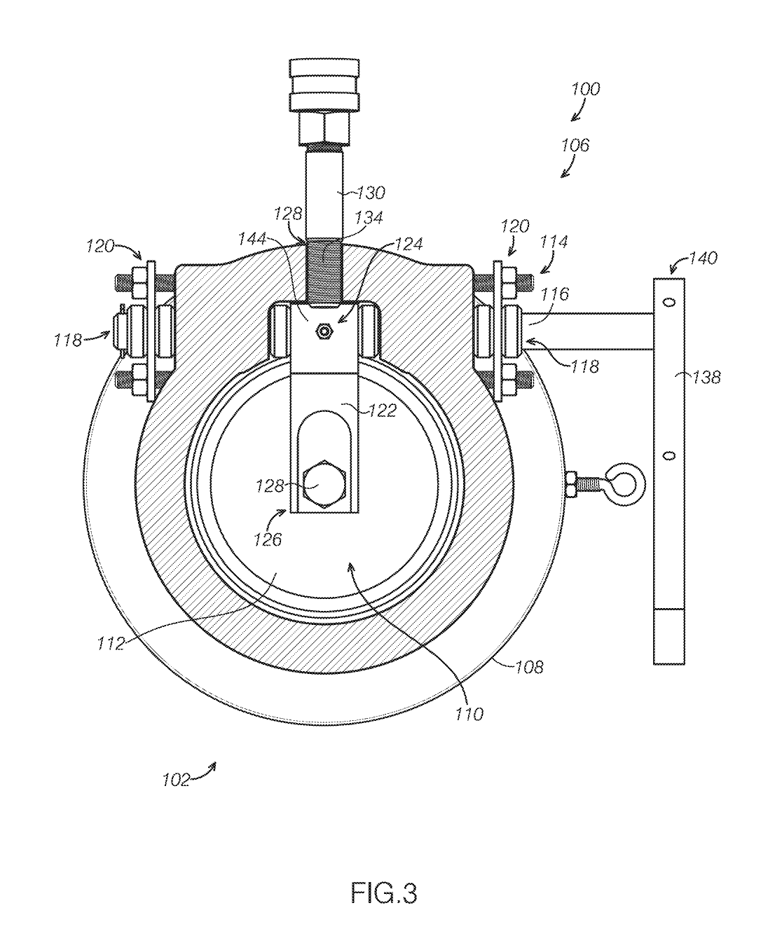

Specifically, port 128 can be a quick-connect access port configured to be releasably coupled to nozzle 130 for high pressure spraying of fluid (e.g., spraying of fluid between 1,750 psi and 5,000 psi). As shown in FIG. 3, nozzle 130 is directly and threadably attachable to port 128 via a threaded section 132 of the nozzle and complimentarily configured threaded section 134 of the port. In alternative examples, the nozzle can be releasably attachable to the port via a different mechanism (e.g., slide fit of the nozzle through a flexible gasket in the port, etc.). In other alternative examples, the nozzle can be fixedly attached to the port, such as the nozzle being welded to the port and/or a sealant being applied to the annular seam between the port and the nozzle. It will be appreciated that the nozzle can be releasably or fixedly attached to the port via any known attachment mechanism or any attachment mechanism yet to be discovered.

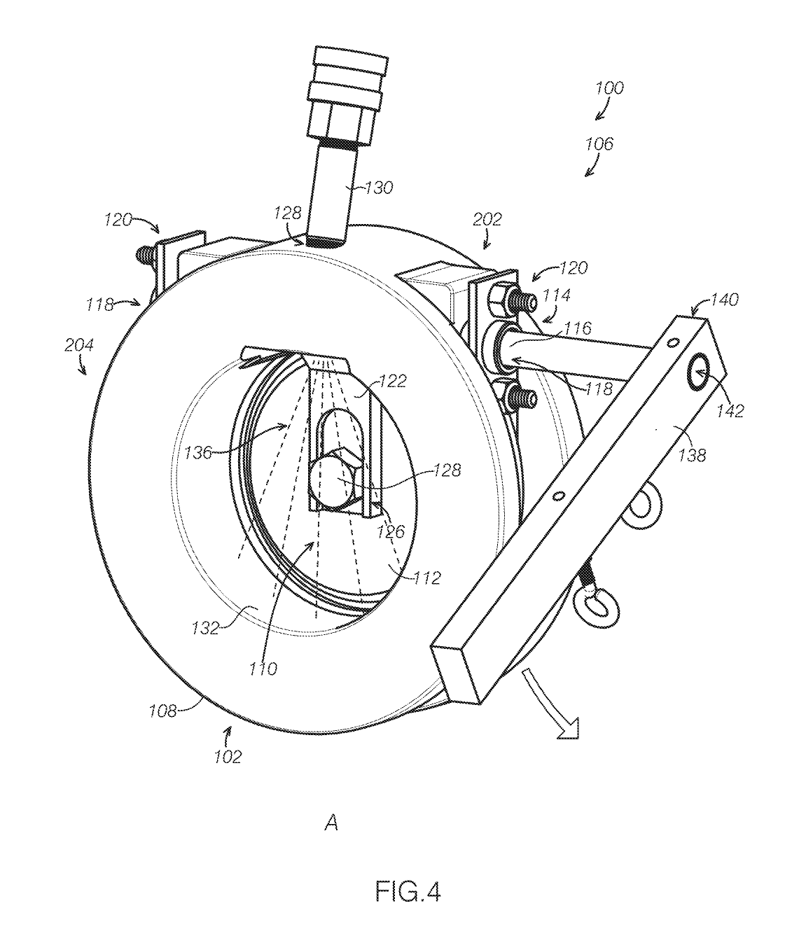

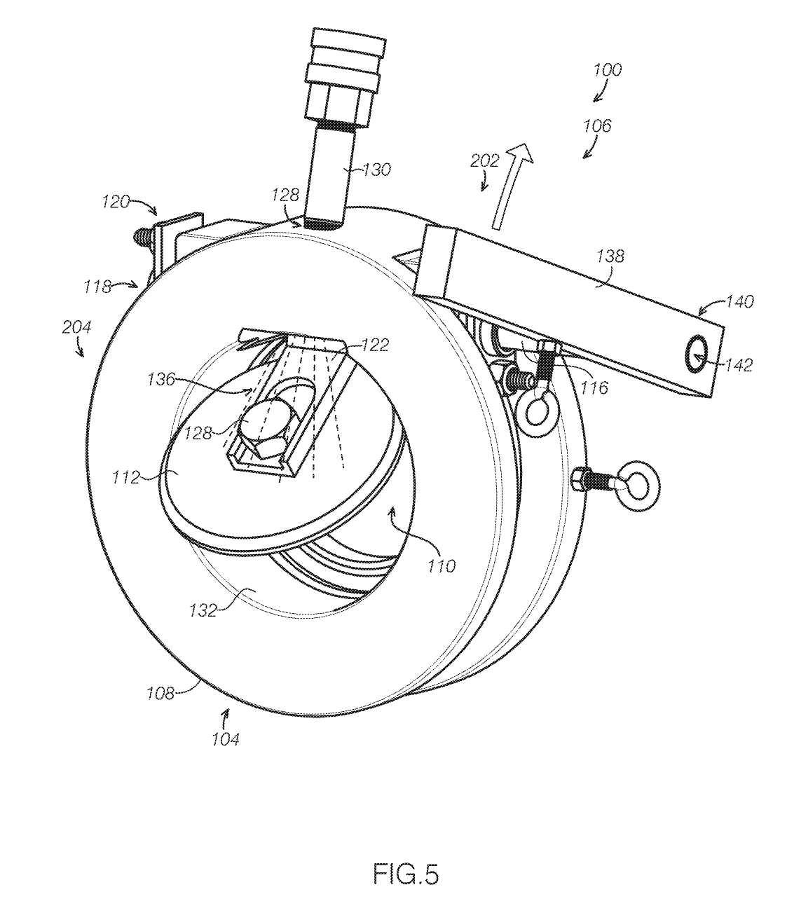

FIGS. 4 and 5 show an example spray pattern 136 created by nozzle 130 when high pressure fluid is sprayed through the nozzle. In other words, nozzle 130 is configured to and/or shaped as to spray liquid in spray pattern 136. In the present example, spray pattern 136 is a substantially vertically aligned fan pattern. More specifically, as shown in FIG. 2, nozzle 130 is disposed at a slight angle (e.g., a 67° angle) relative to vertical axis A-A. The nozzle and the spray pattern are therefore slightly angled away from the hinge mechanism. In alternate examples, the port and the nozzle can be parallel to the vertical axis, angled at a greater degree, angled at a lesser degree, etc.

It will be appreciated that spray pattern 136 is just one example spray pattern and nozzle 130 can be configured to and/or shaped as to spray liquid in a different pattern (e.g., a narrower fan pattern, a wider fan pattern, a cone pattern, a jet or point pattern, etc.). It will be further appreciated that the nozzle can be rotated to spray liquid in a variety of orientations. It will be furthermore appreciated that nozzle 130 can be one of a plurality of interchangeable nozzles configured to releasably couple with the port and spray liquid in different patterns (e.g., a narrower fan pattern, a wider fan pattern, a cone pattern, a jet or point pattern, etc.).

Cleaning mechanism 106 further includes a handle 138. In the present example, handle 138 is operatively coupled to disc 112 and is configured to be grasped by a user for manual movement of disc 112 between closed position 102 and open position 104. In some examples, the handle can be automatically operated via a robotic system and/or a hydraulic system. FIG. 4 shows a substantially downward and counterclockwise movement of the handle to pivot the disc into the closed position, while FIG. 5 shows a substantially upward and clockwise movement of the handle to move the disc into the open position. It will be appreciated that in alternate examples the handle can be disposed in an opposing direction (opposite of the direction shown in FIGS. 4 and 5). Accordingly, in these alternate examples, clockwise movement of the handle can pivot the disc into the closed position and counterclockwise movement can pivot the disc into the open position.

As depicted in FIGS. 2-5, handle 138 is connected at a distal end 140 of rod 116. Specifically, distal end 140 is inserted into and retained in a fixed in a receiving hole 142 of handle 138. In the present example, distal end 140 is fixed within receiving hole 142. It will be appreciated that in other examples the handle can be fixedly attached to the rod via a different mechanism (e.g., welding, attachment members inserted through aligned holes in the handle and the rod, etc.). It will be further appreciated that the handle may be releasably attachable to the rod so that the handle can be removed when not in use.

During cleaning of check valve 100, nozzle 130 can be coupled to port 128. As described above, the nozzle can be one of a plurality of nozzles configured to and shaped as to spray fluid in a selected spray pattern. One example spray pattern is fan spray pattern 136. Spraying of pressurized fluid onto inner surface 132 of side wall 108 and a downstream side of disc 112 can remove, loosen, and/or clear debris that may be trapped in check valve 100.

Further, handle 138 can be operated to manually open and close disc 112 during high pressure spraying of fluid through nozzle 130. Movement of the disc can assist in removal, loosening, and/or clearing of debris from the check valve. As shown in FIG. 5, movement of disc 112 into open position 104 can increase impact of the fluid (in spray patter 136) on the surface of the disc. It will be appreciated that the handle can be operated as many times as necessary to clear debris from the check valve. It will be further appreciated that operation of the handle alone or in combination with high pressure fluid spray from the nozzle can eject debris from the disc and/or the valve seat. In some examples, a user can listen for impact of the disc against the side wall (e.g., a metal-against-metal sound) to indicate that the check valve is clear of debris.

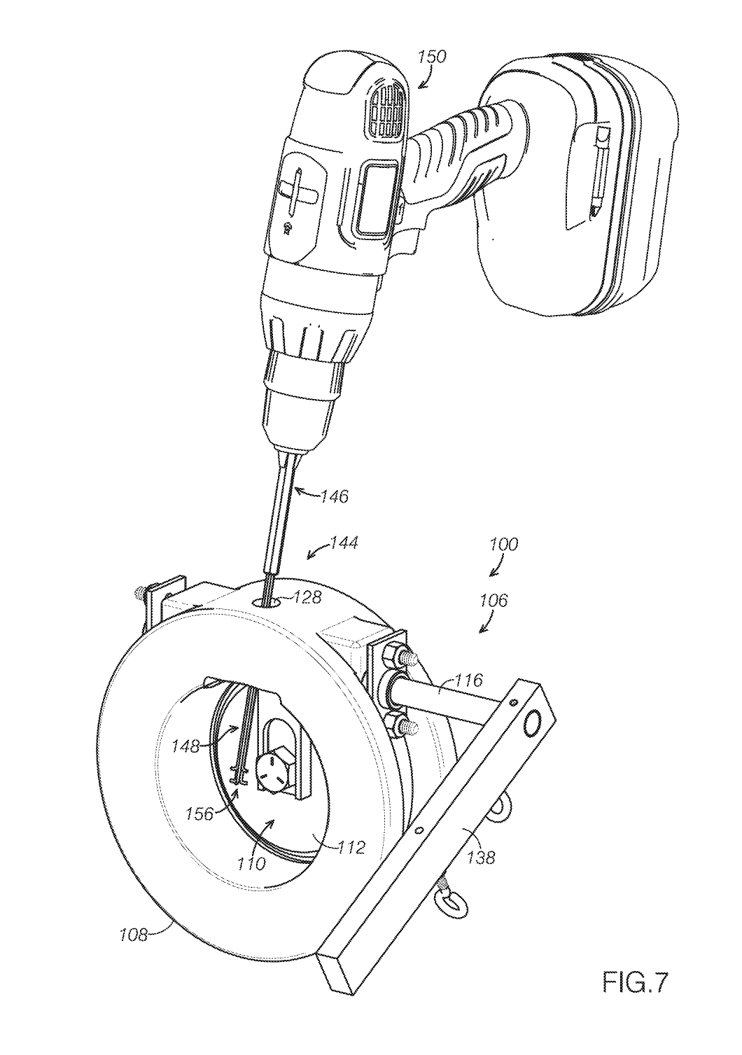

Turning now to FIGS. 6 and 7, a peripheral cleaning device 144 that can be used in combination with cleaning mechanism 106 is shown. Peripheral cleaning device 144 is an elongate member having a first end 146 attachable to a rotation mechanism (e.g., a drill) and a second opposing end 148 that is insertable through port 128. In the present example, peripheral cleaning device 144 is insertable through port 128 when nozzle 130 is removed/uncoupled from the port.

As shown in FIG. 6, first end 146 includes a plurality of flat faces 146 for attachment to a drill 150. It will be appreciated that in alternate examples the first end can have any configuration that is complimentary to the attachment mechanism of the drill. Insertable second end 148 includes a plurality of wires 152. In some examples, the wires are free and/or unattached to each other. In other examples, the rigid wires can be attached to each other (e.g., welded, adhered, etc.). Further, in the present example, the wires are spring type wires that can at least partially flex outwardly when rotated at a high speed. In alternative examples, the wires can be rigid wires.

A distal tip of second end 148 includes a barbed tip 156. Barbed tip 156 is formed by outwardly bent tip end portions of wires 152. In other examples, the second end can be a single rigid member with an attached barbed tip. Further, in other examples, the barbed tip can be at attached barbed tip that is relasable or fixed to the second end member. Furthermore, in even other examples, the barbed tip can include more or fewer wires that are of any desired width and length, and the wires can be bent to form barbs at any desired point along the wire.

FIG. 7 shows peripheral cleaning device 144 in inserted through port 128. In the inserted position, peripheral cleaning device 144 is movable up and down by the user moving drill 150 with an alternating upward and downward movement. Accordingly, second end 148 and barbed tip 156 are moveable within opening 110. Further, second end 148 and barbed tip 156 are rotatable within opening 110 via rotational movement driven by drill 150 (i.e., rotational drive mechanism). Movement (e.g., up and down movement, rotation, etc.) of the peripheral cleaning device within the opening can aid in dislodging, ejecting, and cleaning of debris from the opening and/or the disc by entangling various debris onto the barbs. In some examples, use of the peripheral cleaning device alone can be used to clear blockage from the check valve and/or the pump volute.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method comprising:
creating a closed atmosphere within a piping system;
flowing a fluid through a check valve of the piping system;
wherein the fluid has fibrous waste suspended therein; and
wherein the check valve comprises:
a valve body;
a disc disposed within the valve body and configured to be selectively movable between an open position and a closed position;
a port formed in the valve body downstream of the disc;
a spray nozzle disposed in the port;
a handle operatively coupled to the disc and configured to actuate the disc between the open and closed positions;
in response to the flowing step, collecting a portion of the fibrous waste on the disc;
supplying a cleaning fluid to the nozzle at a pressure between 1750 and 5,000 psi;
in response to the supplying step, spraying a spray pattern onto the disc;
concomitant to the spraying step, actuating the disc via the handle;
in response to the spraying and actuating steps, clearing the fibrous waste from the disc;
maintaining, throughout each step of the method, the closed atmosphere within the piping system.

2. The method of claim 1, wherein the fibrous waste comprises at least one of: sanitary products, toilet paper, and wipes.

3. The method of claim 1, wherein the check valve is a wafer spring resilient check valve.

4. The method of claim 1, wherein the spray pattern comprises a substantially vertically aligned fan pattern.

5. The method of claim 4, wherein the spray pattern is disposed at a 67 degree angle from the vertical.

6. The method of claim 1, wherein the actuating step comprises automatically mechanically operating the handle via a robotic system.

7. The method of claim 1, wherein the actuating step comprises manually operating the handle.

8. A method comprising:
creating a closed atmosphere within a piping system;
flowing a fluid through a check valve of the piping system;
wherein the fluid has fibrous waste suspended therein; and
wherein the check valve comprises:
a valve body;
a disc disposed within the valve body and configured to be selectively movable between an open position and a closed position;
a port formed in the valve body downstream of the disc;
a spray nozzle disposed in the port;
a handle operatively coupled to the disc and configured to actuate the disc between the open and closed positions;
in response to the flowing step, collecting a portion of the fibrous waste on the disc;
supplying a cleaning fluid to the nozzle at a pressure between 1750 and 5,000 psi;
in response to the supplying step, spraying a spray pattern onto the disc;
concomitant to the spraying step, automatically mechanically actuating the disc via a robotic system;
in response to the spraying and actuating steps, clearing the fibrous waste from the disc;
maintaining, throughout each step of the method, the closed atmosphere within the piping system.

9. The method of claim 8, wherein the fibrous waste comprises at least one of: sanitary products, toilet paper, and wipes.

10. The method of claim 8, wherein the check valve is a wafer spring resilient check valve.

11. The method of claim 8, wherein the spray pattern comprises a substantially vertically aligned fan pattern.

12. The method of claim 11, wherein the spray pattern is disposed at a 67 degree angle from the vertical.
